(19) United States
(12) Patent Application Publication
(10) Pub. No.: US 2002/0192038 A1
(43) Pub. Date: Dec. 19, 2002

(54) Method for forming a train of suspended objects transported under the influence of air jets, and conveying section for carrying out said method

(76) Inventors: Joel Trenel, Marcq En Baroeul (FR); Bruno Travail, Villeneuve D'Ascq (FR); Carlos Rodrigues, Lille (FR)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/168,658

(22) PCT Filed: Nov. 30, 2000
(86) PCT No.: PCT/FR00/03352

(30) Foreign Application Priority Data
Dec. 22, 1999 (FR) 99/6296

(51) Int. Cl. B65G 53/16

(52) U.S. Cl. 406/88

(57) ABSTRACT

The method serves to form a train of articles, e.g. plastic bottles, which articles are transported in a conveyor line while being suspended and propelled along the line in a given transport direction under drive from transport air jets. The method comprises the following successive steps implemented in a segment of the conveyor that is referred to as a train-forming segment: a) articles are accumulated in at least a downstream zone of the train-forming segment under drive from transport air jets in an upstream zone of the segment, and by the articles in the downstream zone being braked (and optionally stopped) by drive from air; b) interrupting or reducing the power of the transport air jets in the upstream zone of the train-forming segment so that the articles present in said upstream zone do not penetrate into the downstream zone, while accelerating (or starting) a train of articles under drive from transport air jets in the downstream zone of the train-forming segment.

The present invention relates to the field of pneumatically transporting suspended articles, and more particularly lightweight articles such as, for example, empty plastics bottles or flasks, preforms, etc. The invention relates mainly to a novel method of forming a train of articles, e.g. for the purpose of going through a switch or of filling an in-line machine with a determined number of articles, the invention not being restricted to these purposes. The invention also provides a conveyor segment for implementing the method.

### BACKGROUND OF THE INVENTION

In order to transport lightweight articles, and more particularly plastics bottles or the like, it is already known to use air conveyors fitted with blow means enabling a plurality of air jets to act on the articles in their transport direction.

For articles which can be suspended, such as plastics bottles having respective collars on their necks, for example, it is common practice to use air conveyors fitted with a guide rail, commonly referred to as an under-neck guide, with the articles being guided and transported therealong while they are suspended from their collars or the like. By way of example, that type of conveyor is described in U.S. Pat. No. 4,284,370 or indeed U.S. Pat. No. 5,161,919. A main air duct is used, commonly referred to as a “plenum” which extends along the path of the articles, with a blow channel communicating with the main air duct via blow slots or the like. The main duct is fed with air, e.g. by means of a plurality of fans suitably distributed along its length. This air escapes via the blow slots in the form of a plurality of air jets serving to propel articles along the blow channel. In U.S. Pat. No. 4,284,370, the blow channel is rectangular in section and the blow slots are disposed above the guide rail, thus enabling the articles to be propelled by blowing on them above their collars. In U.S. Pat. No. 5,161,919, the blow channel is in the form of an upside-down V-shape and the blow slots are disposed beneath the guide rail, thereby enabling the articles to be propelled by blowing on them beneath their collars.

In this field of air conveyors, the articles can be transported individually or they can be transported in the form of successive trains, each made up of a given number of articles that are in contact with one another. At present, in order to form a train of articles, purely mechanical means are used that act on command to form a temporary stop abutment across the path of the articles. A train of articles is formed by positioning the mechanical means in the stop abutment position, thereby causing articles to accumulate upstream from the abutment under drive from the transport air jets. After a given lapse of time, supposing the stop abutment is under timer control, or once a sufficient number of articles has accumulated (e.g. using automatic detection by means of an optical cell), the mechanical abutment is withdrawn to allow the accumulated train of articles to go past. By way of example, trains of articles are formed in this way immediately upstream from a switch, during a period of time in which one of the tracks of the switch is closed. Trains are also formed upstream from in-line machines in order to fill such machines at a given rate with some predetermined number of articles. By way of non-limiting example, the machine can be constituted by apparatus for dynamically storing articles, such as the apparatus described in European patent applications Nos. EP-A-0 486 360 and EP-A-0 485 344, or it can be an in-line treatment machine, for example the machine described in European patent application No. EP-A-0 842 877. When transporting hollow articles such as bottles, the machine can also be a filler machine for filling the receptacles in-line.

Using a purely mechanical stop abutment to form a train of articles presents the main drawback of causing articles to become jammed under the effect of the mechanical impacts to which the articles are subjected as they accumulate. In order to limit the magnitude of the negative effects of such impacts, it is necessary to limit the speed at which articles are conveyed, thus harming the throughput rate of the conveyor.

### OBJECTS AND SUMMARY OF THE INVENTION

The present invention seeks to provide a novel method of forming a train of articles which mitigates in particular the above-mentioned drawback of the prior art associated with using purely mechanical stop abutment means for forming a train of articles.

In the method of the invention, the articles are transported in conventional manner in a conveyor line by being suspended and propelled along the line in a given transport direction (SDT) under drive from transport air jets.

In a manner characteristic of the invention, in order to form a train of articles, the following steps are implemented in a conveyor segment referred to as a train-forming segment:

a) accumulating articles at least in a downstream zone of the train-forming segment under drive from transport air jets in an upstream zone of the segment, together with air-driven braking (and optionally stopping) of the articles in the downstream zone; and

b) interrupting or reducing the power of the transport air jets in the upstream zone of the train-forming segment so that the articles present in said upstream zone do not penetrate into the downstream zone, and accelerating (or starting) a train of articles under drive from transport air jets in the downstream zone of the train-forming segment.

In the present specification, the terms “downstream” and “upstream” are defined relative to the transport direction (SDT) of articles along the conveyor line.

Above step a) in the method of the invention in which articles are accumulated can be implemented by stopping the articles or merely by braking them so that their speed becomes slow enough for the articles to accumulate in contact with one another in the form of a train of articles.

Also, in the method of the invention, the air-driven braking of articles during accumulation step a) can be obtained for example (latest solution) by temporarily ceasing to generate transport air jets in the downstream zone of the train-forming segment, the articles stopping solely under the effects of mechanical friction and/or possibly with the help of a mechanical abutment. Using a mechanical abutment in combination with air-driven braking of the articles serves to limit the risks of articles bouncing, and thus to limit the risks of articles jamming while the train is being formed. When this solution is implemented without a mechanical abutment for stopping the articles, it nevertheless presents the drawback of requiring a downstream zone to be implemented of a length that is long enough to achieve the required loss of kinetic energy. This required length increases with increasing article speed at the entrance to the downstream zone of the train-forming segment.

To mitigate this drawback, in a latest preferred solution of the invention, the braking (and optionally stopping) of the articles during accumulation step a) is obtained by means of reverse air jets applied to the articles in the downstream zone of the conveyor segment and acting in the direction opposite to the transport direction (SDT) of the articles. This preferred implementation makes it possible advantageously to obtain the required braking (and optionally stopping) of the articles over a distance that is shorter than that when the articles are braked solely under the action of friction forces. Correspondingly, for comparable length of the downstream zone of the train-forming segment, it is possible to increase the speed at which the articles are conveyed at the entrance to the downstream zone, and consequently to increase the rate at which trains are formed. Mechanical impacts between the bottles are also reduced, thus reducing the risks of bottles becoming jammed during train formation.

According to another preferred characteristic of the invention, the acceleration (or starting) of a train of articles in the downstream zone of the train-forming segment is achieved by means of transport air jets acting beneath or above the suspension points of the articles. This characteristic advantageously enables high power transport air jets to be used without harming the stability of the articles in the train during acceleration (or starting).

The invention also provides a segment for forming a train of articles and enabling the above-specified method to be implemented. The segment is known insofar as it comprises a main air duct which extends over the entire length of the segment together with fan type air feed means which enable air under pressure to be introduced into the inside of the main air duct, which main air duct, once fed with air under pressure, serves to generate transport air jets for propelling suspended articles in a given transport direction (SDT).

In a manner characteristic of the invention, the segment includes air distribution means for distributing the air introduced into the main air duct to enable the air to be distributed over the entire length of the main duct or to enable said air to be concentrated in a downstream zone of the segment.

According to a first feature of the invention, the segment further comprises a reverse blow duct which extends solely in the downstream zone of the segment, which is designed to be fed with air under pressure, and which, once fed with air under pressure, serves to generate reverse air jets directed against the articles in the direction opposite to their transport direction (SDT).

According to a second feature of the invention which can advantageously be implemented on its own or in combination with the above-specified first feature, the segment further comprises a secondary air duct which is designed to be fed with air under pressure and which extends solely in the downstream zone of the segment, and the main and secondary ducts once fed with air under pressure serves to generate transport air jets respectively above and below the suspension points of the articles (or vice versa).

### BRIEF DESCRIPTION OF THE DRAWINGS

Other characteristics and advantages of the invention appear more clearly on reading the following description of a preferred embodiment and implementation of a segment for forming a train of articles, in the field of conveying bottles, which description is given by way of non-limiting example and with reference to the accompanying drawings, in which:

FIG. 1 is a diagrammatic side view of a portion of a bottle conveyor line implementing a switching operation and associated with a segment for forming a train of bottles, which segment constitutes a preferred embodiment of the invention;

FIG. 2 is a diagrammatic plan view of the FIG. 1 conveyor line portion;

FIG. 3 is a simplified cross-section view through the train-forming segment of the conveyor line of FIGS. 1 and 2;

FIG. 4 shows four main successive stages in a preferred implementation of the method of the invention for forming a train; and

FIG. 5 shows the operating steps of an industrial programmable controller used for automatically controlling the main members of the segment for forming a train of bottles.

### MORE DETAILED DESCRIPTION

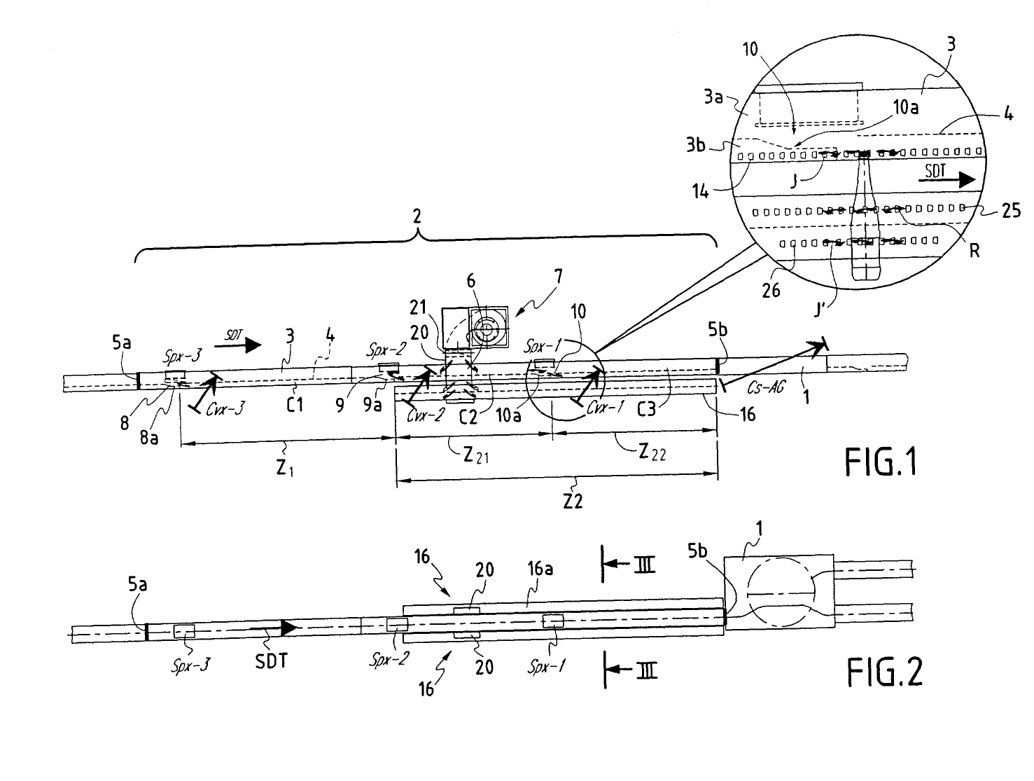

FIGS. 1 and 2 show a portion of a conveyor line which is used for transporting bottles in a given transport direction, represented by the arrow referenced SDT, under drive from jets of air. In this portion, the conveyor line essentially comprises a switch (1 track to 2 tracks) preceded immediately upstream by a segment 2 for forming trains of bottles and made as a preferred embodiment of the invention. The switch 1 can be constituted, for example, by a turntable switch of the type described in European patent application No. EP-A-0 649 804.

The segment 2 comprises a main air duct 3 extending along the entire length of the segment, and subdivided into two inner compartments 3a and 3b by a longitudinal separator sheet 4. In the example shown, at each of its two ends, the main air duct 3 is closed by respective transverse closure sheets 5a and 5b that are substantially leaktight. It should be observed that in the context of the invention, implementing these two closure sheets 5a and 5b is preferred since it makes it possible to isolate the main air duct 3 from the remainder of the conveyor line in terms of air flow. Nevertheless, using these closure sheets is not essential in the context of the invention.

The upper compartment 3a in the main air duct 3 has a main air admission opening.6 which is connected to the outlet from a fan 7. To feed the bottom compartment 3b of the main duct 3 in air, secondary admission openings 8, 9, and 10 are provided through the longitudinal separator sheet 4. The first secondary admission opening 8 is provided downstream from the upstream closure sheet 5a, and preferably in the vicinity of this closure sheet. The second and third secondary admission openings 9 and 10 are provided downstream from the first opening 8, and preferably but in a manner that does not limit the invention, on either side of the main admission opening 6 of the top compartment 3a, as shown in FIG. 1.

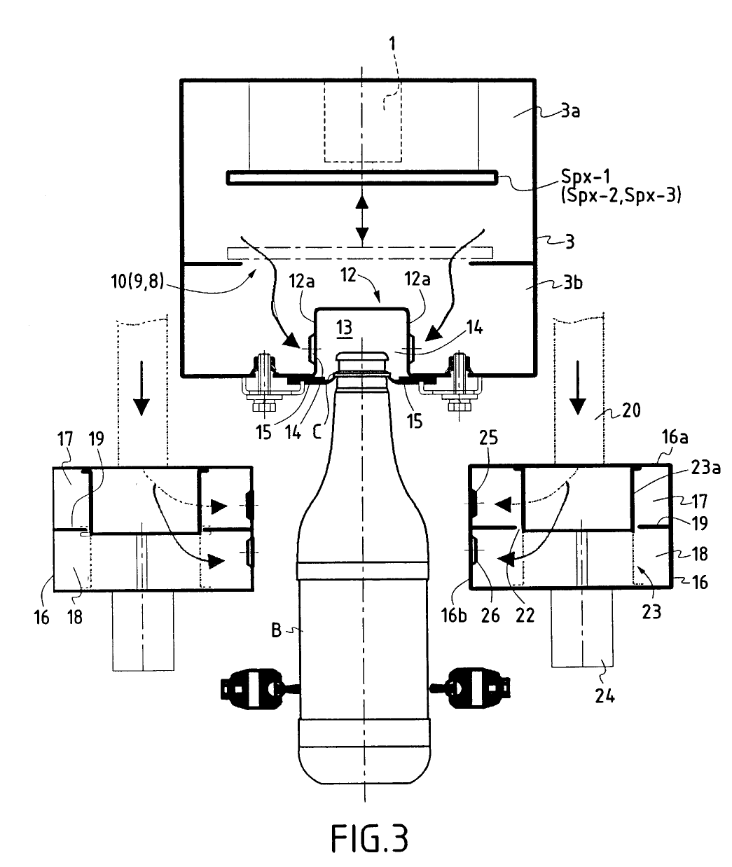

Closure valves Spx-3, Spx-2, and Spx-1 are provided at the secondary admission openings 8, 9, and 10, which closure valves can be actuated by means of respective pneumatic or electric actuators 11. Depending on the high or low position of the valve, the associated secondary admission opening is open or closed (FIG. 3). Immediately upstream from each secondary opening 8, 9, and 10 there are also provided lateral separator walls given respective references 8a, 9a, and 10a, these walls subdividing the bottom compartment 3b into three longitudinally spaced-apart subcompartments C1, C2, and C3.

In the particular embodiment shown (FIG. 3) the bottom wall of the compartment 3b of the main air duct has a setback 12 in its central portion defining a blow channel 13. In the longitudinal side walls 12a of the setback 12 there are provided blow slots (or louvers) 14 which enable the blow channel 13 to be put into communication with the inside of the bottom compartment 3b. These blow slots are provided over substantially the entire length of the longitudinal bottom compartment 3b, i.e. over substantially the entire length of the segment 2. They are made in such a manner that air under pressure inside the bottom compartment 3b escapes through the slots 14 in the form of transport air jets (J) pointing towards the bottles and towards the downstream end of the line, i.e. in the bottle transport direction (SDT).

On the bottom wall of the compartment 3b, in register with the blow channel 13, there are also fixed two facing under-neck guides 15 defining a rail for guiding and supporting bottles. With reference to FIG. 3, it can be seen that each bottle B is provided beneath its mouth with a collar C in conventional manner and that the bottles are transported by being suspended from the collars C on the guide rail formed by the two facing under-neck guides 15.

In the particular variant shown in FIG. 3, the suspended bottles are carried solely by the under-neck guides 15 co-operating with the collars C. Nevertheless, the invention is not limited to this configuration. In another variant that also comes within the context of the invention, it is possible to provide for additional means serving to orient the bottles by acting mechanically on the bottoms thereof, in addition to the bottles being supported by the under-neck guide 15, e.g. of the kind described in U.S. Pat. No. 5,421,678.

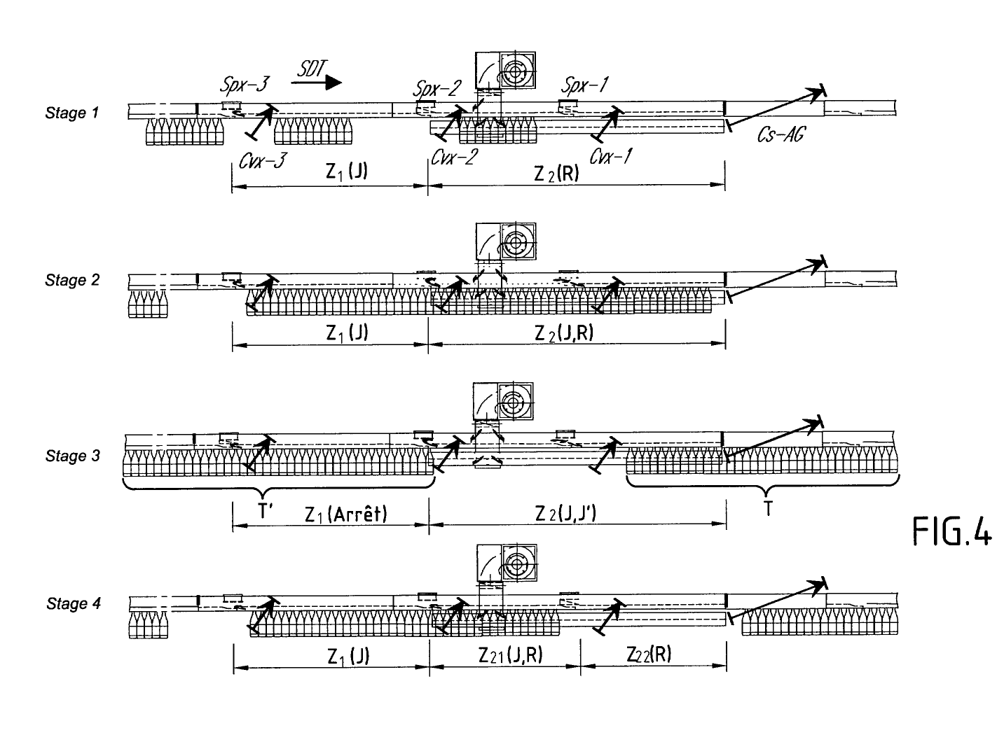

As can be seen more clearly and in greater detail from the description below of the stages of operation shown in FIG. 4, the segment 2 is functionally subdivided into two successive main zones: an upstream zone Z₁ which extends substantially between the separation walls 8a and 9a, and which corresponds to the compartment C1; and a downstream zone Z₂ which extends substantially between the separation wall 9a and the downstream closure sheet 5b. Likewise, this downstream zone Z₂ is itself subdivided into an upstream portion and a downstream portion Z₂₁ and Z₂₂: the upstream portion Z₂₁ extends between the separator walls 9a and 10a and corresponds to the compartment C2; the downstream portion Z₂₂ extends substantially between the separator wall 10a and the downstream closure sheet 5b, and corresponds to the compartment C3.

In operation, when the fan 7 is working, air under pressure penetrates into the main air duct 3 via its top compartment 3a. The valves Spx-3, Spx-2, and Spx-1 serve to control air feed respectively to the bottom compartments of the main air duct 3, i.e.: C1 (upstream zone Z₁); C2 (upstream portion Z₂₁ of the downstream zone Z₂); and C3 (downstream portion Z₂₂ of downstream zone Z₂).

With reference to FIGS. 1 and 3, the segment 2 also has two bottom blow boxes referenced 16 placed facing each other on either side of the bottle path. Each bottom blow box 16 extends substantially along the full length of the downstream zone Z₂ of the segment. Each blow box 16 is subdivided by a separator sheet 19 into top and bottom longitudinal compartments 17 and 18. In another variant, the two longitudinal compartments 17 and 18 can be constituted by two distinct respective blow ducts that are not integrated in a common box. In order to be fed with air under pressure, each blow box 16 has an air admission opening in its top wall 16a connected to the outlet from the fan 7 by a pipe 20 having a register 21 mounted therein (FIG. 1). The bottom compartment 18 is in air communication with the top compartment 17 via an opening 22 provided through the separator sheet 19. A slide valve 23 actuated by an actuator 24 is mounted in this opening. In the blow side wall 16b of each blow box 16, i.e. in its wall facing towards the bottle path, there are provided blow slots 25 leading from the top compartment 17 so that when the compartment 17 is fed with air under pressure that air is allowed to pass from the inside of the compartment to the outside heading towards the bottles in the form of a plurality of reverse air jets R acting in the opposite direction to the bottle transport direction (SDT). These slots 25 are regularly spaced apart along the entire length of the blow box 16. Likewise, the blow wall 16b of the blow box 16 has blow slots 26 level with the bottom compartment 18 and through which transport jets J′ are generated that are directed in the bottle transport direction (SDT) when the compartment 18 is fed with air under pressure.

When the slide member 23a of the valve 23 is in the high position represented by continuous lines in FIG. 3, the air penetrating into the blow box 16 is guided by the slide member of the valve into the bottom compartment 18. Under such circumstances, the transport air jets J′ act on the bottles beneath their points of suspension on the under-neck guides 15. Conversely, when the slide member 23a of the valve 23 is in its low position as represented by dashed lines in FIG. 3, the air entering into the blow compartment 16 is fed almost exclusively to the top compartment 17 and escapes from this compartment in the form of reverse air jets R acting on the bottles below their points of suspension on the under-neck guides 15. In another variant, the blow box 16 could be designed in such a manner that the top compartment 17 generates transport air jets J′ while the bottom compartment 18 generates reverse air jets R.

To automate its operation, the train-forming segment 2 as described above is fitted with three contact-less detector cells, e.g. optical cells. These three cells Cvx-1, Cvx-2, and Cvx-3 are represented by arrows in FIG. 1, being positioned respectively as follows: for Cvx-l at the downstream portion Z₂₂ of the downstream zone Z₂; for Cvx-2 at the upstream portion Z₂₁ of the downstream zone Z₂; and for Cvx-3 at the upstream zone Z₁. The function of these cells is to detect the presence of bottles. Likewise, a detector cell Cs-AG is provided at the switch 1 to detect the presence of bottles in the switch. The electrical detection signals delivered by each of the cells are input to an industrial programmable controller (not shown). This controller responds by controlling the actuators for the valves Spx-1, Spx-2, Spx-3, and the actuator for the slide valve 23.

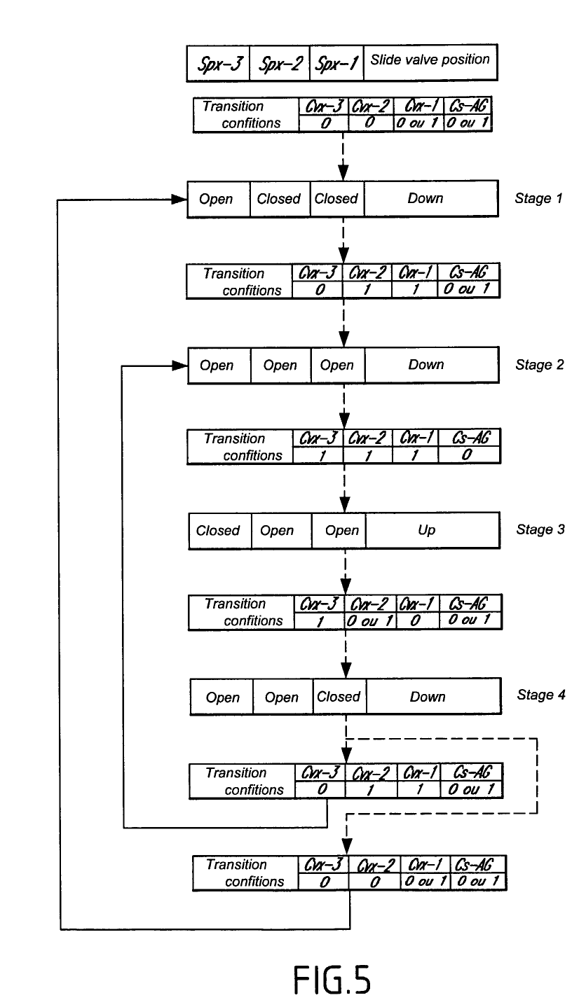

Automatic operation of the train-forming segment 2 is described in greater detail below with reference to FIGS. 4 and 5. To understand FIG. 5, when a bottle is present in register with a detector cell (Cs-AG, Cvx-1, Cvx-2, or Cvx-3) for some minimum length of time (for detecting the presence of bottles), the corresponding state as marked in the “conditions” of FIG. 4 is a 1. Conversely, when said cell does not detect the presence of any bottle, its state is a 0.

The operation of the train-forming segment 2 under automatic control of a programmable industrial controller in response to detection information delivered by the cells Cs-AG, Cvx-1, Cvx-2, and Cvx-3 comprises four main stages.

Stage 1 (Initial Filling):

Stage 1 begins when the cells Cvx-2 and Cvx-3 do not detect the presence of any bottles, and the cells Cvx-1 or Cs-AG optionally being in either state. When the programmable controller is informed that the cells Cvx-2 and Cvx-3 are not detecting any bottles, it automatically causes the valve Spx-3 to open and the valves Spx-1 and Spx-2 to close, and if necessary it controls the slide valve 23 so as to bring its slide member 23a into its low position. In this configuration, transport air jets J are automatically generated in the upstream zone Z₁ of the segment 2 and they act on the bottles above their collars, thereby enabling the bottles to be conveyed at a given speed to the downstream zone Z₂. In the downstream zone Z₂, only reverse jets R are generated, thereby enabling the bottles to be slowed down in the downstream zone Z₂ and enabling them to accumulate in contact with one another so as to form a train of bottles. This first stage continues until both cells Cvx-2 and Cvx-1 detect the presence of bottles. Given the position of detector cell Cvx-2, this first stage continues until the downstream zone Z₂ has been filled with a train of accumulated bottles.

Stage 2 (Filling the Upstream Zone Z₁):

Once both cells Cvx-2 and Cvx-1 detect the presence of bottles, the controller automatically causes the valves Spx-1 and Spx-2 to open. This causes additional transport air jets J to be generated in the upstream and downstream portions Z₂₁ and Z₂₂ of the downstream zone Z₂. It should be observed that the air flow inside the main duct 3 which was initially concentrated solely in the upstream zone Z₁ during stage 1, is now shared substantially uniformly over the entire length of the segment 2, thereby slowing down the speeds of the transport air jets J in the upstream zone Z₁. During this stage, the segment continues to be filled with bottles coming from upstream along the line, while continuing to cause the accumulated train of bottles to advance within the segment. This stage 2 continues until the cell Cvx-3 detects the presence of bottles, i.e. until the upstream zone Z₁ is substantially full.

Stage 3 (Stopping the Train):

When the controller is informed by cells Cvx-3 that bottles are present, it automatically closes the valve Spx-3, and causes the slide valve 23 to bring its slide member 23a into the high position. The effect of closing the valve Spx-3 is to interrupt the transport air jets J in the upstream zone Z₁, and to concentrate the air flow power within the main duct 3 in the downstream zone Z₂. It should be emphasized that the purpose of interrupting the transport air jets J in the upstream zone Z₁ in this way is to prevent the bottles that are present in this zone from being conveyed to the downstream zone Z₂. Thus, in another variant of the invention, it is possible, more generally, merely to reduce the power of the transport air jet J in the upstream zone Z₁ (instead of interrupting them), providing this reduction in power is sufficient to achieve the above-stated purpose.

The effect of operating the slide valve 23 is to interrupt the reverse air jets R and to generate transport air jets J′ in the downstream zone Z₂. The bottles that have accumulated in the downstream zone Z₂ are thus subjected to the transport air jets J and J′ applied both above and below the suspension points of the bottles (the collars C). This causes a train T of bottles to be formed in the zone Z₂ and this train T of bottles to be accelerated so as to go through the switch 1. Meanwhile, the bottles continue to accumulate in the form of an upstream train T′ that is stationary. This stage 3 continues until the cell Cvx-1 no longer detects the presence of bottles.

Stage 4 (Filling Between Cycles):

When the controller is informed that the cell Cvx-1 is not detecting any bottles, it causes the valve Spx-3 to open and the valve Spx-1 to close, and it causes the slide valve 23 to move its slide member into the low position. Transport air jets J are then generated exclusively in the upstream zone Z₁ and in the upstream portion Z₂₁ of the downstream zone Z₂. Reverse air jets R are generated over the entire length of the downstream zone Z₂. This stage 4 serves to fill the train-forming segment between two successive cycles. It continues until either (case one) both cells Cvx-2 and Cvx-1 detect the presence of bottles and the cell Cvx-3 no longer detects the presence of bottles, or else (case two) until the cells Cvx-2 and Cvx-3 no longer detect the presence of bottles. In case one, a new operating cycle starts directly with the second stage (stage 2). In case two, since the number of bottles in the segment is insufficient, a new operating cycle is started from the first stage (stage 1) in order to perform return to initial filling of the segment.

The train-forming segment of the invention, a preferred embodiment of which is described above, serves advantageously to feed apparatus positioned downstream from said segment automatically and cyclically with trains of accumulated bottles, each train presenting a predetermined number of bottles. In the example described above, the downstream apparatus is constituted by a switch 1. Nevertheless this is merely one particular application of the invention. In other applications, the apparatus could be constituted by any inline processing machine, and in particular by apparatus for dynamically storing bottles of the kind described in European patent application EP-A-0 485 344 or EP-A-0 842 877. Likewise, the train-forming apparatus could advantageously be implemented at the outlet from a machine such as a blower or a labeler, for example.

Compared with conventional solutions for forming trains solely by means of mechanical stops, the train-forming segment of the invention serves advantageously to reduce the magnitude of impacts between bottles, thereby reducing the risk of bottles becoming jammed and increasing the rate at which trains can be formed. The invention also makes it possible, particularly in the preferred embodiment with reverse air jets, to eliminate any use of mechanical stops for stopping the bottles while a train is being formed. Nevertheless, the invention is also advantageous when implemented in combination with a mechanical stop, since the air-powered braking of articles upstream from such a mechanical abutment also serves to reduce the magnitude of the impacts and to reduce the risk of articles becoming jammed.

1. A method of forming a train of articles which articles being transported in a conveyor line while being suspended and propelled along the line in a given transport direction under drive from transport air jets, the method comprising the following successive steps implemented in a conveyor segment referred to as a train-forming segment:
a) accumulating articles at least in a downstream zone of the train-forming segment under drive from transport air jets in an upstream zone of the segment, together with air-driven braking (and optionally stopping) of the articles in the downstream zone; and
b) interrupting or reducing the power of the transport air jets in the upstream zone of the train-forming segment so that the articles present in said upstream zone do not penetrate into the downstream zone, and accelerating (or starting) a train of articles under drive from transport air jets in the downstream zone of the train-forming segment.

2. A method according to claim 1, wherein the braking (or stopping) of the articles during the accumulation step a) is achieved by means of reverse air jets applied to the articles in the downstream zone of the conveyor segment and directed in the direction opposite to the transport direction of the articles.

3. A method according to claim 1, wherein the acceleration (or starting) of a train of articles in the downstream zone of the segment is achieved by means of transport air jets acting beneath or above the suspension points of the articles.

4. A segment for forming trains of suspended articles, the segment being of the type comprising a main air duct extending over the entire length of the segment, and fan type air feed means enabling air to be introduced under pressure into the inside of the main air duct, which main air duct, once fed with air under pressure, enables transport air jets to be generated for propelling suspended articles in a given transport direction, the segment further comprising a reverse blow duct extending solely in a downstream zone of the segment, which duct is designed to be fed with air under pressure and serves, once fed with air under pressure, to generate reverse air jets acting on the articles in the direction opposite to their transport direction, and air distribution means for distributing the air introduced inside the main air duct making it possible to distribute the air over the entire length of the duct, or else to concentrate said air in the downstream zone of the segment.

5. A segment according to claim 4, wherein the main air duct is subdivided by a longitudinal separator partition into a main compartment and a secondary compartment, wherein the air feed means are connected to the main compartment, wherein the secondary compartment communicates for air feed with the main compartment via at least one upstream admission opening provided in the upstream zone of the segment, and via at least one downstream admission opening provided in the downstream zone of the segment, and wherein the air distribution means include a closure valve for closing the upstream admission opening.

6. A segment for forming trains of suspended articles, the segment being of the type comprising a main air duct extending over the entire length of the segment and fan type air feed means enabling air under pressure to be introduced into the inside of the main air duct, the main air duct once fed with air under pressure serving to generate transport air jets for propelling suspended articles in a given transport direction, the segment further comprising a secondary air duct which is designed to be fed with air under pressure and which extends solely in a downstream zone of the segment, and air distribution means for distributing the air introduced into the main air duct enabling the air inside the main duct to be distributed over the entire length of the duct or enabling said air to be concentrated in the downstream zone of the segment, and wherein the main and secondary air ducts, once fed with air under pressure, enable transport air jets to be generated respectively above and below the suspension points of the articles (or vice versa).

7. A segment according to claim 6, wherein the main air duct is subdivided by a longitudinal separator partition into a main compartment and a secondary compartment, wherein the air feed means are connected to the main compartment, wherein the secondary compartment communicates for air feed with the main compartment via at least one upstream admission opening provided in the upstream zone of the segment and via at least one downstream admission opening provided in the downstream zone of the segment, and wherein the air distribution means comprise a closure valve for closing the upstream admission opening.

8. A segment according to claim 6, further comprising a reverse blow duct which is designed to be fed with air under pressure and which, once fed with air under pressure, serves to generate reverse air jets acting on the articles in the direction opposite to their transport direction.

9. A segment according to claim 8, wherein the reverse and secondary blow ducts are constituted respectively by two longitudinal compartments of a blow box fitted with an air-distributing slide valve.

10. A conveyor line for conveying suspended articles, the line comprising a succession of conveyor segments enabling the suspended articles to be transported under the drive of transport air jets, and being wherein at least one of the conveyor segments of the line is a segment for forming trains of articles according to claim 4.

11. A conveyor line according to claim 10, including a switch immediately downstream from a train-forming segment.

12. A conveyor line according to claim 11, including apparatus for dynamically storing articles in line, which apparatus is located immediately downstream from a train-forming segment.
